(19) United States
(12) Patent Application Publication
(10) Pub. No.: US 2015/0185010 A1
(43) Pub. Date: Jul. 2, 2015

(54) ACCELERATION SENSOR

(71) Applicant: SAMSUNG ELECTRO-MECHANICS CO., LTD., Gyeonggi-Do (KR)

(72) Inventors: Chang Hyun LIM, Gyeonggi-Do (KR); Seung Hun HAN, Gyeonggi-Do (KR); Sung Jun LEE, Gyeonggi-Do (KR)

(73) Assignee: SAMSUNG ELECTRO-MECHANICS CO., LTD., Gyeonggi-Do (KR)

(21) Appl. No.: 14/246,765

(22) Filed: Apr. 7, 2014

(30) Foreign Application Priority Data
Dec. 26, 2013 (KR) 10-2013-0164220

(51) Int. Cl. G01C 19/5705

(52) U.S. Cl. CPC G01C 19/5705

(57) ABSTRACT

Embodiments of the invention provide an acceleration sensor including a mass body, flexible beams coupled to the mass body, a supporting part having the flexible beams connected thereto and supporting the mass body so as to be floatable, and a lower cover coupled to the supporting part to cover the mass body, wherein the lower cover is provided with a buffering beam part so as to be opposite to the mass body.

### CROSS REFERENCE TO RELATED APPLICATION

This application claims the benefit of and priority under 35 U.S.C. §119 to Korean Patent Application No. KR 10-2013-0164220, entitled “Acceleration Sensor,” filed on Dec. 26, 2013, which is hereby incorporated by reference in its entirety into this application.

### BACKGROUND

1. Field of the Invention

The present invention relates to an acceleration sensor.

2. Description of the Related Art

Generally, an inertia sensor has been used for a vehicle, an airplane, a mobile communication terminal, a toy, and the like, which requires a three-axis acceleration and angular velocity sensor measuring acceleration and angular velocity of an X axis, a Y axis, and a Z axis, and has been developed for high performance and miniaturization in order to detect fine acceleration.

The acceleration sensor among the inertia sensors as mentioned above includes technical characteristics converting motions of a mass body and a flexible beam into an electrical signal and is classified into a piezo-resistive type detecting the motion of the mass body from a resistance change of a piezo-resistive element disposed on the flexible beam, a capacitive type detecting the motion of the mass body from a capacitance change between fixed electrodes, and the like.

In addition, the piezo-resistive type uses an element having a resistance value which is changed by stress. For example, where tensile stress is distributed, the resistance value is increased, and where compressive stress is distributed, the resistance value is decreased.

In addition, since an acceleration sensor of a piezo-resistive type, according to the conventional art, for example, as described in U.S. Patent Publication No. 2006/0156818, decreases an area of a beam to increase sensitivity, it may be vulnerable to impact, need to perform a complex process when forming a stopper to prevent over-displacement of the mass body, and decrease productivity.

### SUMMARY

Accordingly, embodiments of the present invention provide an acceleration sensor capable of preventing damage to a flexible beam and a mass body vulnerable to impact by forming a buffering beam part having a hole form therein on a cover of the acceleration sensor and damping through the buffering beam part at the time of an occurrence of over-displacement of the mass body as well as capable of simply implementing a damping part through a process of manufacturing an upper cover and a lower cover while not including a separate damping part.

According to a preferred embodiment of the present invention, there is provided an acceleration sensor including a mass body, flexible beams coupled to the mass body, a supporting part having the flexible beams connected thereto and supporting the mass body so as to be floatable, and a lower cover coupled to the supporting part to cover the mass body, wherein the lower cover is provided with buffering beam parts so as to be opposite to the mass body.

In accordance with an embodiment of the invention, the buffering beam part is provided with a plurality of holes.

In accordance with an embodiment of the invention, the buffering beam part is further provided with a coating layer which is opposite to the mass body and is formed of a soft material.

In accordance with an embodiment of the invention, the lower cover is provided with a hollow part formed toward the other side of the buffering beam part having one side which is opposite to the mass body.

In accordance with an embodiment of the invention, the buffering beam part is provided with a plurality of holes, the lower cover is provided with a hollow part formed toward the other side of the buffering beam part having one side which is opposite to the mass body, and the plurality of holes and the hollow part are formed by an anisotropic etching process and an isotropic etching process.

In accordance with an embodiment of the invention, the lower cover is coupled to the supporting part by a bonding material, and a height of the bonding material becomes an interval between the mass body and the buffering beam part.

According to another preferred embodiment of the present invention, there is provided an acceleration sensor including a mass body, flexible beams coupled to the mass body, a supporting part having the flexible beams connected thereto and supporting the mass body so as to be floatable, a lower cover coupled to the supporting part to cover the mass body, and an upper cover coupled to one surface of the supporting part to cover one side of the flexible beam, wherein the lower cover is provided with a buffering beam part so as to be opposite to the mass body, and the upper cover is provided with a buffering beam part so as to be opposite to the mass body and the flexible beam.

In accordance with an embodiment of the invention, the buffering beam parts of the lower cover and the upper cover are provided with a plurality of holes.

In accordance with an embodiment of the invention, the buffering beam parts of the lower cover and the upper cover are further provided with a coating layer which is opposite to the mass body and are formed of a soft material.

In accordance with an embodiment of the invention, the lower cover and the upper cover are provided with hollow parts formed toward the other side of the buffering beam parts having one side which is opposite to the mass body.

In accordance with an embodiment of the invention, the buffering beam parts of the lower cover and the upper cover are provided with a plurality of holes, the lower cover is provided with a hollow part formed toward the other side of the buffering beam part having one side which is opposite to the mass body, and the plurality of holes and the hollow part are formed by an anisotropic etching process and an isotropic etching process.

In accordance with an embodiment of the invention, the lower cover and the upper cover are coupled to the supporting part by a bonding material, a height of the bonding material becomes an interval between the mass body and the buffering beam part of the lower cover and become an interval between the flexible beam or the mass body and the buffering beam part of the upper cover.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view schematically showing an acceleration sensor, in accordance with a first embodiment of the present invention.

FIG. 2 is a schematic cross-sectional view taken along a line A-A of the acceleration sensor shown in FIG. 1, in accordance with the first embodiment of the present invention.

FIG. 3A is a plan view schematically showing a damping part in the acceleration sensor shown in FIG. 2, and FIG. 3B is a plan view schematically showing a damping part, in accordance with another embodiment of the present invention.

FIG. 4 is a cross-sectional view schematically showing an acceleration sensor, in accordance with a second embodiment of the present invention.

FIGS. 5 and 6 are schematic use state views of the acceleration sensor shown in FIG. 4, in accordance with the second embodiment of the present invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

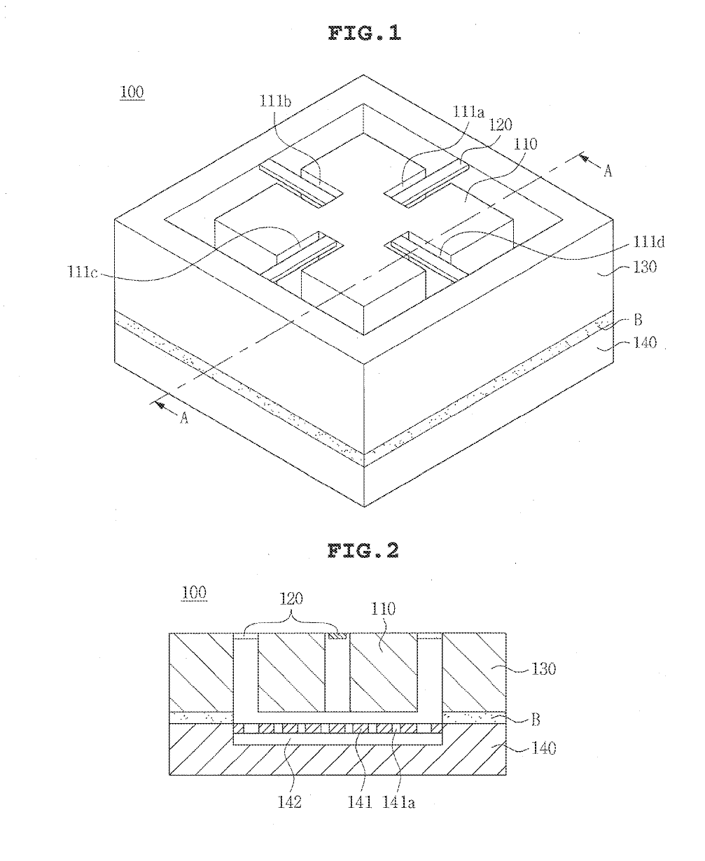

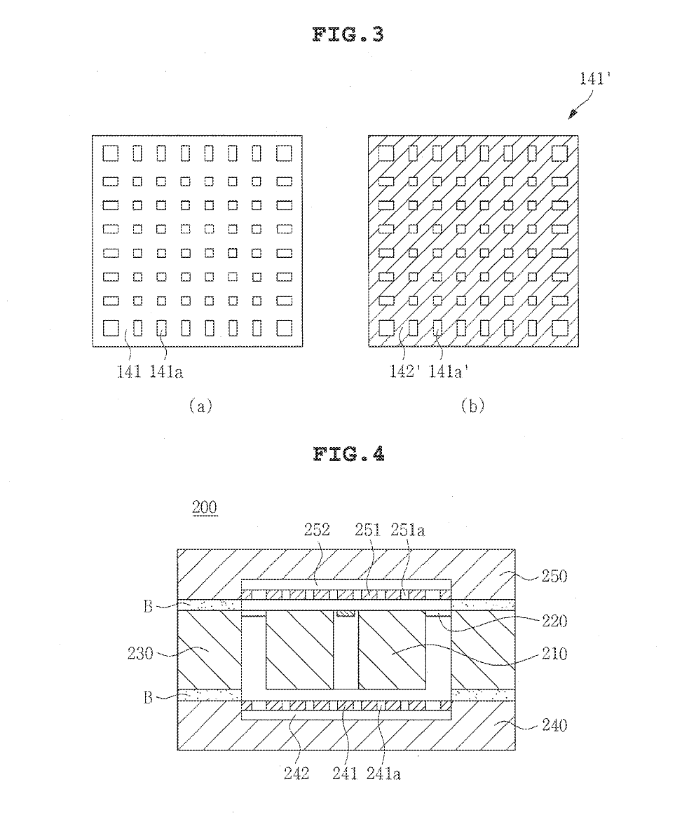

FIG. 1 is a perspective view schematically showing an acceleration sensor, FIG. 2 is a schematic cross-sectional view taken along a line A-A of the acceleration sensor shown in FIG. 1, FIG. 3A is a plan view schematically showing a damping part in the acceleration sensor shown in FIG. 2, and FIG. 3B is a plan view schematically showing a damping part, in accordance with preferred embodiments of the present invention.

In accordance with at least one embodiment of the invention, an acceleration sensor 100 includes a mass body 110, flexible beams 120, a supporting part 130, and a lower cover 140. More specifically, the mass body 110 is displaceably coupled to the flexible beam 120 and is displaced by inertial force, external force, Coriolis force, driving force, or the like.

In addition, although a case in which the mass body 110 has a substantially square pillar shape is shown as an example, the mass body 110 is not limited to having the above-mentioned shape, but may have all shapes known in the art such as a cylindrical shape, and the like.

In accordance with at least one embodiment of the invention, the mass body 110 has four groove parts 111a, 111b, 111c, and 111d formed at an equidistant interval so that the flexible beams 120 are each connected to the mass body 110 from every direction and are formed in a rectangular parallelepiped shape.

In accordance with at least one embodiment of the invention, in order for a center part of the mass body 110 to be displaceably fixed by the flexible beams 120, the four groove parts 111a, 111b, 111c, and 111d are formed so as to be extended from the outer part of the mass body 110 to the center part thereof, and the four flexible beams 120 are coupled to the center part of the mass body 110 from every direction.

Next, the flexible beam 120 is formed in a plate shape and is formed by a flexible substrate, such as a membrane, a beam, or the like having elasticity, so that the mass body 110 is displaced. In addition, one end of the flexible beam 120 is connected to the center part of the mass body 110 through the groove parts 111a, 111b, 111c, and 111d of the mass body 110, and the other end thereof is connected to the supporting part 130.

In addition, one surface of the flexible beam 120, in accordance with at least one embodiment, is provided with a detecting unit or detector (not shown) (hereinafter referred to as a “detecting unit”) for detecting a displacement of the mass body, where the detecting unit may be variously formed by a piezoelectric body, a piezoresistive body, and the like.

Next, the supporting part 130 has the flexible beams 120 coupled to the mass body 110, such that it supports the mass body 110 to be floatable and is formed in a hollow type in which the mass body 110 is displaceable, thereby securing a space in which the mass body 110 is displaced.

In accordance with at least one embodiment, the lower cover 140 is coupled to one surface of the supporting part 130 to cover one side of the mass body. In addition, the lower cover 140 is provided with a buffering beam part 141 for restraining an over-displacement of the mass body according to a drop of the acceleration sensor, external impact, or the like. The buffering beam part 141 is formed, so as to be opposite to the mass body and is formed in a beam shape. In addition, the buffering beam part 141 is provided with a plurality of holes 141a to improve buffering effect.

In accordance with at least one embodiment, the lower cover 140 is provided with a hollow part 142 by forming the buffering beam part 141, where the hollow part 142 is formed toward the other side of the buffering beam part 141 having one side which is opposite to the mass body.

In accordance with at least one embodiment, the plurality of holes 141a and the hollow part 142 are formed by sequentially performing anisotropic and isotropic etching processes on a wafer.

In accordance with at least one embodiment of the invention, FIG. 3B is a plan view schematically showing a damping part according to another preferred embodiment of the present invention. As shown, a buffering beam part 141′ is provided with a plurality of holes 141a′ and a coating layer 142′, so as to be opposite to the mass body.

In accordance with at least one embodiment, the coating layer 142′ is formed by depositing a soft material. As an example thereof, parylene is coated on the buffering beam part 141′ by the coating, thereby making it possible to form the coating layer 142′.

In addition, the lower cover 140 is coupled to the supporting part 130 by a bonding material B and forms an interval between the mass body 110 and the buffering beam parts 141 and 141′ by a height of the bonding material B. Thus, an end portion of the supporting part 130 is formed on the same surface as an end portion of the mass body 110 and an upper surface of the lower cover 140 coupled to the supporting part is formed on the same surface as a surface of the buffering beam part 141, such that a height of the bonding material B becomes an interval between the mass body 110 and the buffering beam parts 141 and 141′.

In addition, the acceleration sensor 100 according to the preferred embodiment of the present invention couples the lower cover and the supporting part to each other by a silicon direct bonding method instead of the bonding material B.

By the configuration as described above, the acceleration sensor 100 according to a first preferred embodiment of the present invention prevents damage to the mass body by the buffering beam parts formed on the lower cover, even in the case of the over-displacement of the mass body and simply implements the damping part through a process of manufacturing the lower cover, while not including a separate damping part.

FIG. 4 is a cross-sectional view schematically showing an acceleration sensor, in accordance with a second embodiment of the present invention. As shown in FIG. 4, the acceleration sensor 200 is configured to further include an upper cover as compared to the acceleration sensor 100 according to the first preferred embodiment of the present invention as shown in FIG. 2.

More specifically, the acceleration sensor 200 includes a mass body 210, a flexible beam 220, a supporting part 230, a lower cover 240, and an upper cover 250.

In addition, the mass body 210 is coupled to the flexible beam 220, so as to be displaceable and the flexible beam 220 is formed by a flexible substrate such as a membrane, a beam, or the like having elasticity, so that the mass body 210 is displaced.

In accordance with at least one embodiment, one end of the flexible beam 220 is connected to the mass body 210 and the other end thereof is connected to the supporting part 230.

In accordance with at least one embodiment, one surface of the flexible beam 220 is provided with a detecting unit or detector (not shown) (hereinafter referred to as a “detecting unit”) for detecting a displacement of the mass body, where the detecting unit may be variously formed by a piezoelectric body, a piezoresistive body, and the like.

In addition, the lower cover 240 is coupled to one surface of the supporting part 230 to cover one side of the mass body. In addition, the lower cover 240 is provided with a buffering beam part 241 for restraining an over-displacement of the mass body according to a drop of the acceleration sensor, external impact, or the like. The buffering beam part 241 is formed, so as to be opposite to the mass body and is formed in a beam shape. In addition, the buffering beam part 241 is provided with a plurality of holes 241a to improve buffering effect.

Next, the upper cover 250 is coupled to one surface of the supporting part 230 to cover one side of the flexible beam 220. Thus, the upper cover 250 is coupled to the supporting part 230 so as to be opposite to the lower cover 240 and covers the detecting unit formed on the flexible beam 220.

In addition, similar to the lower cover, the upper cover 250 is provided with the buffering beam part 251, so as to be opposite to the mass body and the flexible beam, and the buffering beam part 251 is provided with a plurality of holes 251a to improve buffering effect.

In accordance with at least one embodiment, the upper cover 250 is provided with a hollow part 252 by forming the buffering beam part 251, where the hollow part 252 is formed toward the other side of the buffering beam part 251 having one side which is opposite to the mass body.

In accordance with at least one embodiment, the plurality of holes 251a and the hollow part 252 are formed by sequentially performing anisotropic and isotropic etching processes on a wafer.

In addition, the upper cover 250 is also provided with a coating layer, so as to be opposite to the mass body 210 and the flexible beam 220, as shown in FIG. 3B as a damping part according to another preferred embodiment of the present invention. In addition, as described above, the coating layer is formed, for example, by depositing a soft material.

In addition, the lower cover 240 and the upper cover 250 are coupled to the supporting part 230 by the bonding material B and form an interval from the buffering beam parts 241 and 251 by a height of the bonding material B, in accordance with at least one embodiment of the invention.

Thus, the height of the bonding material B becomes an interval between the mass body 210 and the buffering beam part 241 of the lower cover 240, and becomes an interval between the flexible beam 220 or the mass body 210 and the buffering beam part 251 of the upper cover 250.

In addition, the acceleration sensor 200 according to the preferred embodiment of the present invention couples the lower cover and the supporting part to each other and couples the upper cover and the supporting part to each other by a silicon direct bonding method instead of the bonding material B.

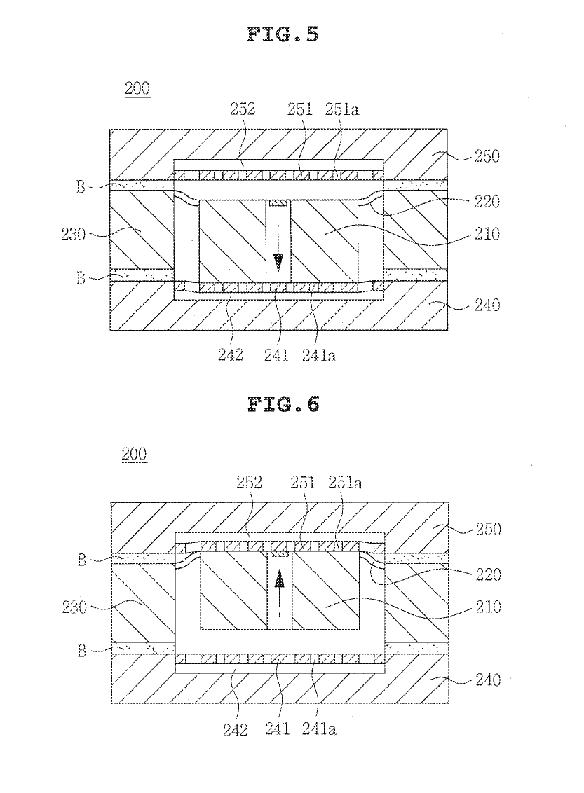

FIGS. 5 and 6 are schematic use state views of the acceleration sensor shown in FIG. 4, in accordance with the second embodiment of the present invention. As shown, in the case in which the mass body 210 is downwardly over-displaced by a drop of the acceleration sensor 200 or external impact as shown in FIG. 5 by an arrow, the mass body 210 contacts the buffering beam part 241 of the lower cover 240.

In accordance with at least one embodiment of the invention, since the buffering beam part 241 is provided with the plurality of holes 241a, the buffering beam part 241 elastically supports the mass body 210, thereby preventing damage to the mass body 210.

Next, in the case in which the mass body 210 is upwardly over-displaced as shown in FIG. 6 by an arrow, the mass body 210 contacts the buffering beam part 251 of the upper cover 250.

In this case, since the buffering beam part 251 is provided with the plurality of holes 251a, the buffering beam part 251 elastically supports the mass body 210, thereby preventing damage to the mass body 210.

By the configuration as described above, the acceleration sensor 200 according to the second preferred embodiment of the present invention prevents damage to the flexible beam and the mass body vulnerable to impact by the buffering beam parts 251 and 241 formed on the upper cover and the lower cover, even in the case of the over-displacement of the mass body and simply implements the damping part through a process of manufacturing the upper cover and the lower cover, while not including a separate damping part.

According to the preferred embodiment of the present invention, the acceleration sensor capable of preventing damage to the flexible beam and the mass body vulnerable to impact by forming the buffering beam part having the hole form therein on the cover of the acceleration sensor and damping through the buffering beam part at the time of an occurrence of over-displacement of the mass body as well as capable of simply implementing the damping part through the process of manufacturing the upper cover and the lower cover while not including the separate damping part may be obtained.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An acceleration sensor comprising:
a mass body;
flexible beams coupled to the mass body;
a supporting part having the flexible beams connected thereto and supporting the mass body so as to be floatable; and
a lower cover coupled to the supporting part to cover the mass body,
wherein the lower cover is provided with a buffering beam part so as to be opposite to the mass body.

2. The acceleration sensor as set forth in claim 1, wherein the buffering beam part is provided with a plurality of holes.

3. The acceleration sensor as set forth in claim 2, wherein the buffering beam part is further provided with a coating layer which is opposite to the mass body and is formed of a soft material.

4. The acceleration sensor as set forth in claim 1, wherein the lower cover is provided with a hollow part formed toward the other side of the buffering beam part having one side which is opposite to the mass body.

5. The acceleration sensor as set forth in claim 1, wherein the buffering beam part is provided with a plurality of holes, the lower cover is provided with a hollow part formed toward the other side of the buffering beam part having one side which is opposite to the mass body, and the plurality of holes and the hollow part are formed by an anisotropic etching process and an isotropic etching process.

6. The acceleration sensor as set forth in claim 1, wherein the lower cover is coupled to the supporting part by a bonding material, and a height of the bonding material becomes an interval between the mass body and the buffering beam part.

7. An acceleration sensor comprising:
a mass body;
flexible beams coupled to the mass body;
a supporting part having the flexible beams connected thereto and supporting the mass body so as to be floatable;
a lower cover coupled to the supporting part to cover the mass body; and
an upper cover coupled to one surface of the supporting part to cover one side of the flexible beam,
wherein the lower cover is provided with a buffering beam part so as to be opposite to the mass body, and
wherein the upper cover is provided with a buffering beam part so as to be opposite to the mass body and the flexible beam.

8. The acceleration sensor as set forth in claim 7, wherein the buffering beam parts of the lower cover and the upper cover are provided with a plurality of holes.

9. The acceleration sensor as set forth in claim 8, wherein the buffering beam parts of the lower cover and the upper cover are further provided with a coating layer which is opposite to the mass body and is formed of a soft material.

10. The acceleration sensor as set forth in claim 7, wherein the lower cover and the upper cover are provided with hollow parts formed toward the other side of the buffering beam parts having one side which is opposite to the mass body.

11. The acceleration sensor as set forth in claim 7, wherein the buffering beam parts of the lower cover and the upper cover are provided with a plurality of holes, the lower cover is provided with a hollow part formed toward the other side of the buffering beam part having one side which is opposite to the mass body, and the plurality of holes and the hollow part are formed by an anisotropic etching process and an isotropic etching process.

12. The acceleration sensor as set forth in claim 7, wherein the lower cover and the upper cover are coupled to the supporting part by a bonding material, a height of the bonding material becomes an interval between the mass body and the buffering beam part of the lower cover and becomes an interval between the flexible beam or the mass body and the buffering beam part of the upper cover.
